(19) United States
(12) Patent Application Publication
(10) Pub. No.: US 2015/0334354 A1
(43) Pub. Date: Nov. 19, 2015

(54) MIRROR ELEMENT FOR VEHICLE

(71) Applicant: MAGNA MIRRORS OF AMERICA, INC., Holland, MI (US)

(72) Inventors: John T. Uken, Jenison, MI (US); Darryl P. De Wind, West Olive, MI (US); Gregory A. Huizen, Hudsonville, MI (US)

(21) Appl. No.: 14/712,200

(22) Filed: May 14, 2015

Related U.S. Application Data
(60) Provisional application No. 62/032,036, filed on Aug. 1, 2014.
(60) Provisional application No. 62/006,392, filed on Jun. 2, 2014.
(60) Provisional application No. 62/001,350, filed on May 21, 2014.
(60) Provisional application No. 61/993,333, filed on May 15, 2014.

(51) Int. Cl. H04N 7/18; B60R 1/04

(52) U.S. Cl. CPC H04N 7/181; B60R 1/04; H04N 2101/00

(57) ABSTRACT

A visor assembly for a vehicle includes a visor element configured to pivotally attach at an interior portion of a vehicle so as to be pivotable between a non-use position, where the visor is disposed along a roof of the vehicle, and a use position, where the visor element is disposed at least partially along a windshield of the vehicle. A vanity mirror reflective element includes a glass mirror substrate and a mirror reflector coating. The vanity mirror reflective element is disposed at the visor element so as to be viewable by a driver of the vehicle when the visor element is pivoted to the use position. The mirror substrate has a rounded perimeter edge that is exposed at the visor element and is viewable by the driver of the vehicle when the visor element is pivotally attached at the interior portion of the vehicle and in the use position.

### CROSS REFERENCE TO RELATED APPLICATIONS

The present application is related to U.S. provisional applications, Ser. No. 62/032,036, filed Aug. 1, 2014; Ser. No. 62/006,392, filed Jun. 2, 2014, Ser. No. 62/001,350, filed May 21, 2014, and Ser. No. 61/993,333, filed May 15, 2014, which are hereby incorporated herein by reference in their entireties.

### FIELD OF THE INVENTION

The present invention relates generally to the field of mirror elements for use in rearview mirror assemblies and visors for vehicles.

### BACKGROUND OF THE INVENTION

It is known to provide a mirror reflective element and a bezel for an interior or exterior rearview mirror assembly of a vehicle. The interior mirror reflective element is adjustably mounted to an interior portion of a vehicle, such as via a double ball pivot or joint mounting configuration where the mirror casing and reflective element are adjusted relative to the interior portion of a vehicle by pivotal movement about the double ball pivot configuration.

### SUMMARY OF THE INVENTION

The present invention provides an interior rearview mirror assembly that has a mirror reflective element with a rounded or radiused perimeter edge. The mirror reflective element may be adjustably mounted at an interior portion of a vehicle and may be adjustable to adjust the driver's rearward view, such as through a rear window of the vehicle, via the driver viewing the mirror reflective element. Optionally, the mirror reflective element may be mounted at a visor of the vehicle, and may comprise a vanity mirror, with the radiused or rounded perimeter edge exposed at the visor and without any bezel or frame established around the perimeter of the reflective element.

In accordance with another aspect of the present invention, an interior rearview mirror assembly for a vehicle includes a reduced thickness or thin mirror head pivotally mounted or attached at a mirror mount that is configured to attach at an interior portion of a vehicle equipped with the interior rearview mirror assembly. The mirror head comprises a mirror casing and a mirror reflective element, and does not include a printed circuit board (but may have circuitry or an accessory disposed therein for electrical connection to circuitry of a circuit board). A circuit board may be disposed in said mirror mount and has circuitry associated with at least one accessory of the mirror head of interior rearview mirror assembly. Wiring passes through the pivot element to electrically connect the at least one accessory to the circuitry. The mirror head comprises a reduced profile mirror casing having a thickness between a front generally planar surface of said mirror reflective element and a rear surface of said mirror casing, and wherein said thickness is less than about 25 mm.

The circuitry of the circuit board of the mirror mount controls or powers at least the accessory or accessories at the mirror head. For example, the mirror head may include one or more cameras or sensors that are electrically connected to the circuitry of the mirror mount via the wiring, and/or the mirror reflective element may comprise a variable reflectance electro-optic (such as electrochromic) mirror reflective element having terminals or leads that are electrically connected to the circuitry of the mirror mount via the wiring.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly in accordance with the present invention;

FIG. 2 is a sectional view of another interior rearview mirror assembly of the present invention, shown with a bezel that attaches at the reflective element and attachment plate and that attaches the attachment plate and reflective element and bezel construction to the mirror casing;

FIG. 3 is a sectional view of another interior rearview mirror assembly of the present invention, shown with a bezel that attaches at the mirror casing to hold the reflective element and attachment plate at the mirror casing;

FIG. 4 is a sectional view of another interior rearview mirror assembly of the present invention, shown with a bezel that attaches at the mirror casing to hold the reflective element and attachment plate at the mirror casing;

FIG. 5 is a plan view of a vanity mirror assembly in accordance with the present invention;

FIG. 5A is a side view of the vanity mirror assembly of FIG. 5;

FIG. 6 is a perspective view of a thin interior rearview mirror assembly in accordance with the present invention;

FIG. 7 is a partially exploded perspective view of the thin interior rearview mirror assembly of FIG. 6, with the cover of the mounting structure removed to show the circuit board therein;

FIG. 8 is a top plan view of the thin interior rearview mirror assembly of FIG. 6;

FIG. 9 is a front perspective view of the thin interior rearview mirror assembly of FIG. 6;

FIG. 10 is a side elevation of the thin interior rearview mirror assembly of FIG. 6;

FIG. 11 is an exploded perspective view of the thin interior rearview mirror assembly of FIG. 6;

FIGS. 12 and 13 are photographs of an exemplary interior rearview mirror assembly in accordance with the present invention, showing the thickness of the mirror head relative to a U.S. Quarter;

FIG. 14 is a sectional view of a thin EC interior rearview mirror assembly in accordance with the present invention;

FIG. 15 is a sectional view of another thin EC interior rearview mirror assembly in accordance with the present invention;

FIG. 16 is a sectional view of another thin EC interior rearview mirror assembly in accordance with the present invention;

FIG. 17 is a sectional view of another thin EC interior rearview mirror assembly in accordance with the present invention;

FIG. 18 is a side elevation of another thin EC interior rearview mirror assembly in accordance with the present invention;

FIG. 19 is a perspective view of the mirror head of the thin EC interior rearview mirror assembly of FIG. 18, with the mounting structure removed from the mirror assembly;

FIG. 20 is a perspective view of the mirror head of FIG. 19, shown with a mounting structure for pivotally attaching the mirror head at an interior portion of a vehicle;

FIG. 21 is a perspective view of the assembly of FIG. 20, shown with a circuit board disposed at the mounting structure;

FIG. 22 is a perspective view of the thin EC interior rearview mirror assembly of FIG. 18, with a housing or casing disposed at the mounting structure;

FIG. 23 is a perspective view of a thin EC interior rearview mirror assembly in accordance with the present invention;

FIG. 24 is a perspective view of another thin EC interior rearview mirror assembly in accordance with the present invention;

FIG. 25 is a perspective view of another thin EC interior rearview mirror assembly in accordance with the present invention; and

FIG. 26 is a table showing different views of the thin EC interior rearview mirror assemblies of FIGS. 23-25.

### DESCRIPTION OF THE PREFERRED EMBODIMENTS

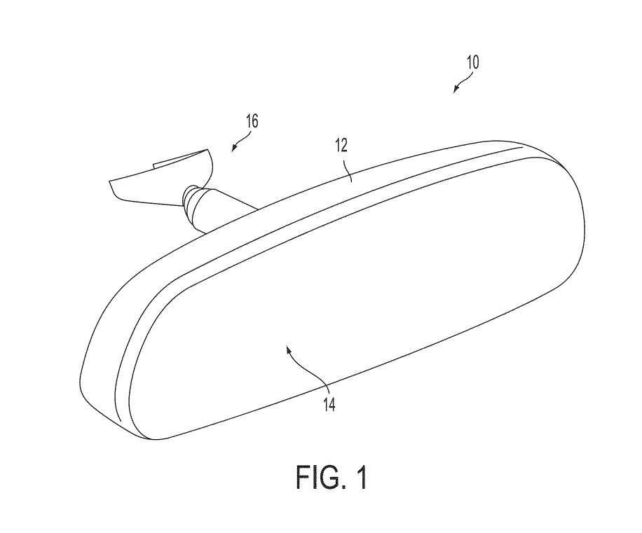

Referring now to the drawings and the illustrative embodiments depicted therein, an interior rearview mirror assembly 10 for a vehicle includes a casing 12 and a reflective element 14 positioned at a front portion of the casing 12 (FIG. 1). In the illustrated embodiment, mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 16. The mirror reflective element may comprise a prismatic reflective element or a variable reflectance mirror reflective element that varies its reflectance responsive to electrical current applied to conductive coatings or layers of the reflective element.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled perimeter edge around the reflective element and with no overlap onto the front surface of the reflective element (such as by utilizing aspects of the mirror assemblies described in U.S. Pat. Nos. 7,255,451; 7,289,037; 7,360,932; 8,049,640; 8,277,059 and/or 8,529,108, which are hereby incorporated herein by reference in their entireties).

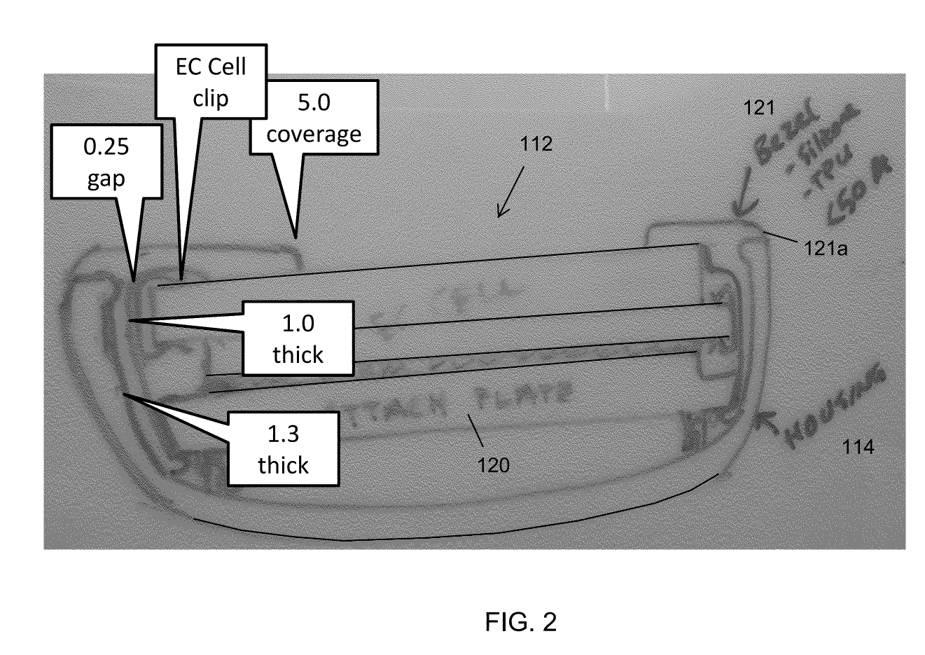

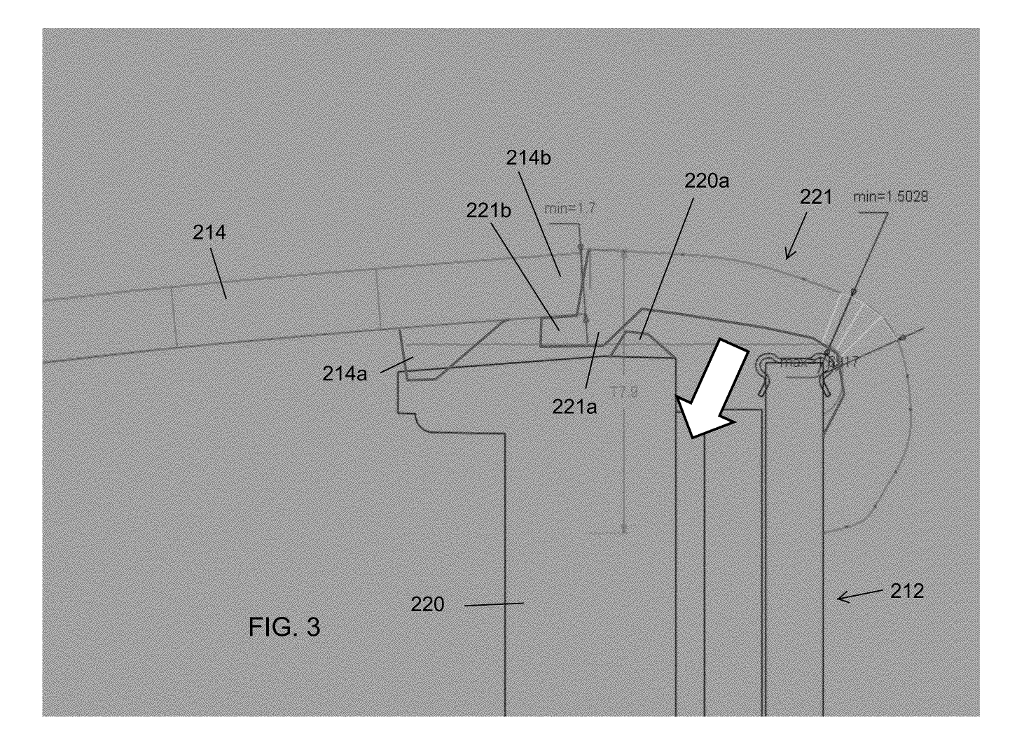

Optionally, and such as shown in FIG. 2, an electro-optic mirror reflective element 112 may have an attachment plate or backplate 120 at the rear of the reflective element and a bezel portion 121 that protrudes between the periphery of the mirror reflective element and the mirror casing or housing 114 and that has a radiused or rounded perimeter edge 121a so that the perimeter edge of the bezel portion is exposed to and viewable by the driver of the vehicle (when the mirror assembly is normally mounted in the vehicle and the driver is normally operating or driving the vehicle). As shown in FIG. 2, the bezel portion 121 is formed to overlap or encompass the perimeter edge region of the reflective element, which is attached at the attachment plate 120 via a layer of adhesive or tape or the like. The reflective element may include a perimeter band that is disposed about the periphery of the rear surface of the front substrate to hide the perimeter seal of the reflective element from view by a person viewing the mirror.

The bezel portion 121 may comprise a separate frame portion or part (separate from the attachment plate) that circumscribes the reflective element and the attachment plate 120 and provides a zero gap, line to line fit around the reflective element. The bezel portion (at a peripheral portion of the attachment plate) may be adhered at the periphery of the reflective element and at the attachment plate, or may receive and circumscribe and retain the attachment plate and reflective element within the bezel portion. The bezel portion may comprise a flexible or resilient or elastomeric material, or may comprise silicone or TPU, and may have a material hardness of less than about a durometer 50 Shore A or thereabouts.

As shown in FIG. 2, when the reflective element and attachment plate are received in the bezel portion, the bezel portion may overlap the front surface of the reflective element by about 5 mm or less, and may have a small gap (such as about 0.25 mm or thereabouts) between the bezel portion and the reflective element clip (such as the electrical connector or clip at a perimeter portion of the front substrate of the reflective element). As can be seen with reference to FIG. 2, the bezel portion may be received within the mirror casing, and may have a press-fit connection or may snap attach at the mirror casing, whereby the outer perimeter edge 121a provides a smooth transition between a front surface of the bezel portion and the side surface of the mirror casing.

Optionally, the bezel portion may snap attach at the attachment plate. For example, and with reference to FIG. 3, a bezel portion 221 may overlap a perimeter and front periphery of a reflective element 212, and may include a tab 221a that engages and snaps over a corresponding continuous tab 220a of an attachment plate 220 disposed at and attached at the rear of the reflective element. The bezel portion 221 may comprise any suitable material, and may comprise a polypropylene material or the like (which may be a lower cost and quieter material as compared to the likes of PC and ABS), and may either use lifters or strip off the tool without action in the tool. The bezel portion thus may snap over a continuous snap ledge or lip 220a on the attachment plate 220 (or localized or just at the top and bottom so the sides can pull in during snapping). The mirror casing or housing 214 may then snap to the attachment plate 220 (such as via a tab 214a that engages a corresponding tab at the attachment plate) and, in so doing, may trap the end or lip 221b of the bezel portion 221 with a small amount of overlap of the casing lip 214b over the end portion or lip 221b of the bezel 221.

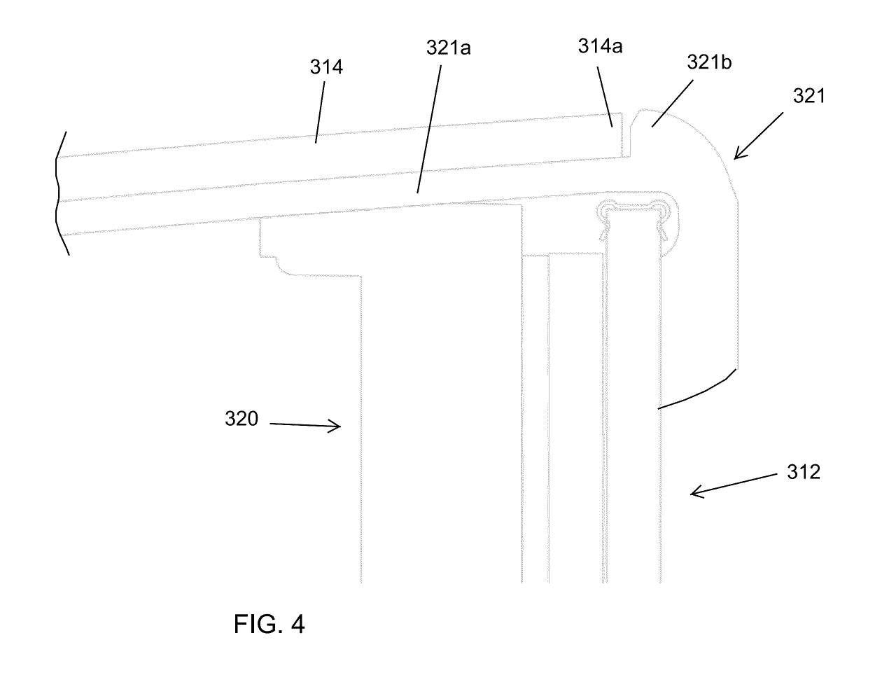

Optionally, and with reference to FIG. 4, a bezel portion 321 may overlap a perimeter and front periphery of a reflective element 312, and may include a wall or portion 321a that circumscribes the reflective element 312 and attachment plate 320 and that is press fit within the mirror casing 314 and between the mirror casing 314 and attachment plate 320. The mirror casing or housing 314 may receive the portion 321a of the bezel portion 321 therein, whereby an outer portion 321b of the bezel portion may be disposed at (and optionally spaced from) the outer end or lip or rim 314a of the mirror casing 314.

Thus, the present invention provides a bezel portion and attachment plate and reflective element construction or assembly for attaching at an open end of a mirror casing, with the bezel portion providing an exposed rounded or radiused outer edge to provide a transition between a forward portion of the bezel portion and the outer surface of the mirror casing. The bezel portion is configured to attach at the reflective element and/or the attachment plate and the bezel portion-reflective element-attachment plate construction may readily attach at the mirror casing.

Optionally, the reflective element may provide the outer radiused or curved or rounded exposed edge (whereby the mirror assembly may not include a bezel portion and may instead include an attachment portion that may attach the attachment plate and reflective element at the mirror casing). For example, the mirror assembly may have a rear substrate of an electro-optic or electrochromic reflective element nested in the mirror casing, and with the front substrate having curved or beveled perimeter edges, or such as a mirror assembly having a prismatic reflective element that is disposed at an outer perimeter edge of the mirror casing and with the prismatic substrate having curved or beveled perimeter edges, such as described in U.S. Des. Pat. Nos. D633,423; D633,019; D638,761 and/or D647,017, and/or U.S. Publication No. US-2014-0313563, and/or International Publication Nos. WO 2010/124064; WO 2011/044312; WO 2012/051500; WO 2013/071070 and/or WO 2013/126719, which are all hereby incorporated herein by reference in their entireties (and with electrochromic and prismatic mirrors of such construction are commercially available from the assignee of this application under the trade name INFINITY™ mirror).

Optionally, the mirror assembly may have a mirror reflective element that has a front glass substrate that overlaps a portion of the mirror casing or housing, with the front glass substrate having a curved or rounded or radiused perimeter edge (such as by utilizing aspects of the mirror assemblies described in International Publication Nos. WO 2010/124064; WO 2011/044312; WO 2012/051500; WO 2013/071070 and/or WO 2013/126719, which are hereby incorporated herein by reference in their entireties). The glass substrate may have a thickness of about 3.2 mm and a radius of curvature of the perimeter edge of about 2.8 mm or thereabouts, such that the full radius (the curved transition from the generally planar front substrate to the generally planar surface of the mirror casing) is on the glass perimeter edge. The outermost portion of the perimeter edge of the front glass substrate extends slightly outboard of the mirror casing such that the mirror casing (or bezel portion) is not exposed or viewable around the glass substrate by a person viewing the mirror assembly from in front of the glass substrate.

Optionally, a mirror reflective element having a radiused glass substrate (having a radiused perimeter edge) may be used for other mirror assemblies of a vehicle. For example, the mirror reflective element may be used for an interior rearview mirror assembly that is adjustably disposed at an interior portion of a vehicle and is adjustable to adjust a driver's view rearward of the vehicle and through a rear window of the vehicle. Optionally, for example, the mirror reflective element may be used for an exterior rearview mirror assembly at a side of the vehicle that is adjustable to adjust a driver's view sideward and rearward of the vehicle. Optionally, the mirror reflective element may be used as an interior vanity mirror at a sun visor of the vehicle.

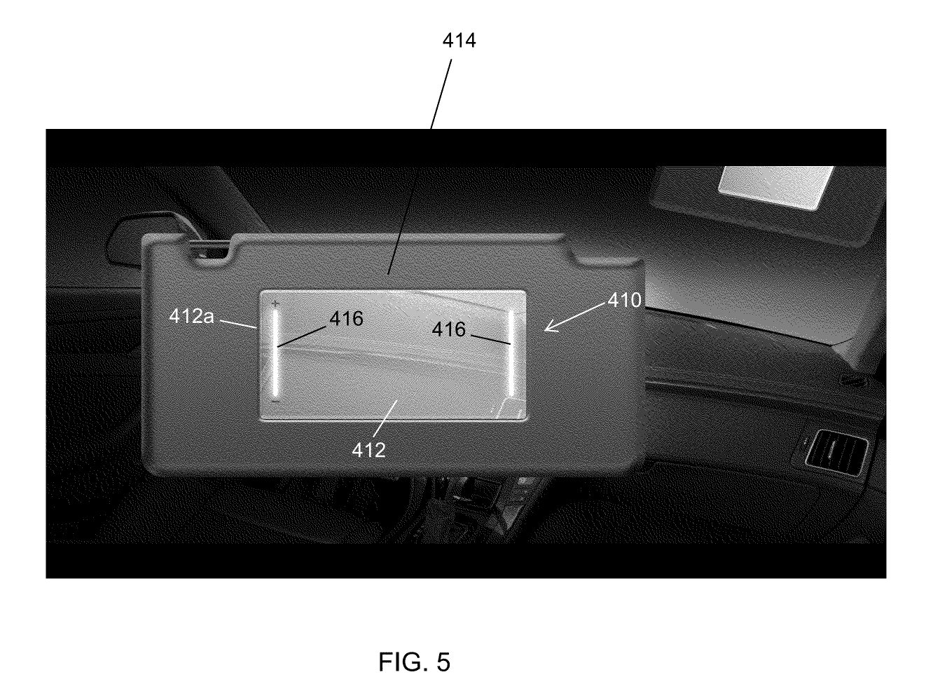

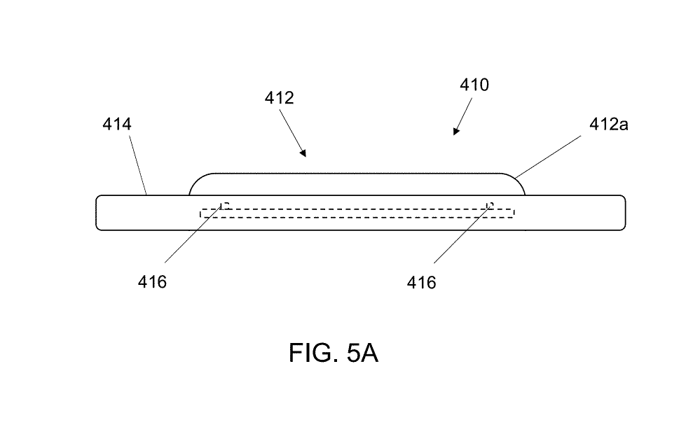

For example, and with reference to FIGS. 5 and 5A, a vanity mirror assembly 410 includes a mirror reflective element 412 that is disposed at a visor element 414 (such as a sun visor element) of a vehicle that is pivotally attached at an interior portion of a vehicle and, when attached at the interior portion of the vehicle, is pivotable between a non-use position, where the visor is disposed along a roof of the vehicle, and a use position, where the visor element is disposed at least partially along the windshield of the vehicle. The mirror element 412 comprises a generally planar glass substrate having a mirror reflector coating at a surface thereof, with a radiused or curved or rounded perimeter edge 412a. The mirror element 412 may be attached at the visor 414 via any suitable means and may protrude from the surface of the visor so that the radiused perimeter edge is exposed and not recessed within the visor. For example, the mirror element may be disposed at or attached or mounted at a generally planar surface of the visor element, or may be partially recessed at the visor element, such that the radiused perimeter edge 412a is exposed and protrudes from the generally planar surface of the visor element (such as shown in FIG. 5A). Optionally, the mirror element may otherwise be substantially or fully recessed at the visor but with the radiused perimeter edge exposed and viewable by the driver of the vehicle when the visor is in its use position.

The radiused or rounded perimeter edge may be polished so as to provide a water clear edge or it may be frosted or otherwise treated or ground or polished, depending on the particular application of the vanity mirror. Optionally, the glass substrate may be inset or recessed slightly into the visor, and may emphasize the radiused perimeter edge while hiding/protecting the back edge and tape interface between the mirror substrate and the visor. Optionally, although shown as a generally rectangular shaped mirror element, the mirror element of the vanity mirror of the present invention may comprise any selected shape or customized shape or the like.

Optionally, the vanity mirror may not have any cover so that the radiused or rounded edges and the front surface of the mirror element are exposed when the sun visor is flipped downward for use. Optionally, a slide or flip cover could still be utilized (so as to cover or conceal the mirror element when the vanity mirror is not in use), depending on the particular application and desired appearance of the vanity mirror and visor. Optionally, it is envisioned that, for mirrors without a cover, the mirror element may utilize an electro-optic or electrochromic or solid polymer matrix (SPM) medium to dim or darken the mirror element to effectively “cover” the mirror element so as to block glare at the mirror element, such as when a user is using the visor to block sun and not to view their reflection in the vanity mirror.

In the illustrated embodiment, the mirror 410 includes lighting 416 to provide enhanced lighting at the user's face when the user is viewing the mirror (and thus the mirror may be electrically connected to a power source of the vehicle, such as via a wiring harness of the vehicle that is routed to the sun visor). The lighting may be provided via any suitable illumination sources, such as one or more lights disposed at the visor at or around the mirror. Optionally, and as shown in FIGS. 5 and 5A, the lighting may be provided behind the mirror element. For example, the mirror reflector may be ablated or removed or masked where the lights are disposed, so that illumination emitted by the light sources (such as light emitting diodes or the like), when activated, passes through the ablated regions of the mirror element. Optionally, the mirror reflector may comprise a partially reflective and partially light transmissive or transflective coating, whereby the illumination emitted by the light sources, when activated, may pass through the transflective mirror coating. Optionally, the perimeter edges of the mirror element may be illuminated, such as by utilizing aspects of the mirror assemblies described in U.S. Publication Nos. US-2013-0088884 and/or US-2014-0293169, which are hereby incorporated herein by reference in their entireties.

Optionally, and such as shown in FIG. 5, the illumination may be provided in the form of light bars (with a strip or light source disposed behind an ablated strip (such as about 50 percent ablated light bars or the like) or behind a transflective mirror reflector or the like). Optionally, the ground perimeter edge may be ablated or frosted around the outside edge of the mirror element, with backlighting (such as via white light or colored light or RGB light or the like) to illuminate the perimeter region of the mirror element. Optionally, a touch sensor may be provided at the mirror element (and such as at or near one of the lights), whereby a user may activate and deactivate and adjust the intensity of the lights via touching or swiping the sensor region. For example, and with reference to FIG. 5, a user may activate and/or increase the intensity of the vanity mirror lights by swiping upward along the left side light region, and may deactivate and/or decrease the intensity of the vanity mirror lights by swiping downward along the left side light region. The touch sensor or user input may utilize aspects of the sensors described in U.S. Pat. No. 8,154,418 and/or U.S. Publication Nos. US-2014-0293169 and/or US-2014-0022390, which are hereby incorporated herein by reference in their entireties.

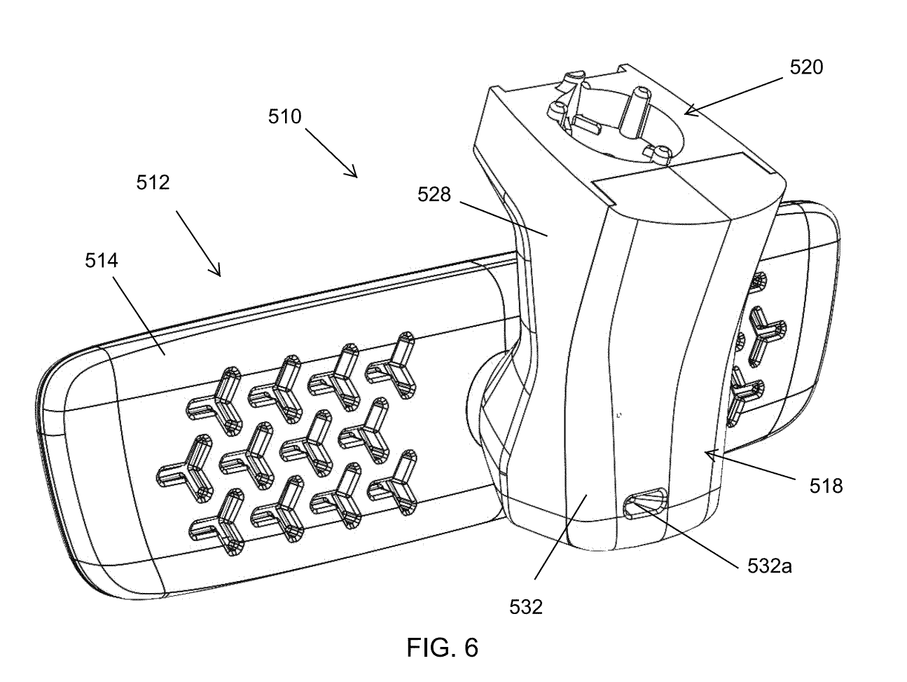

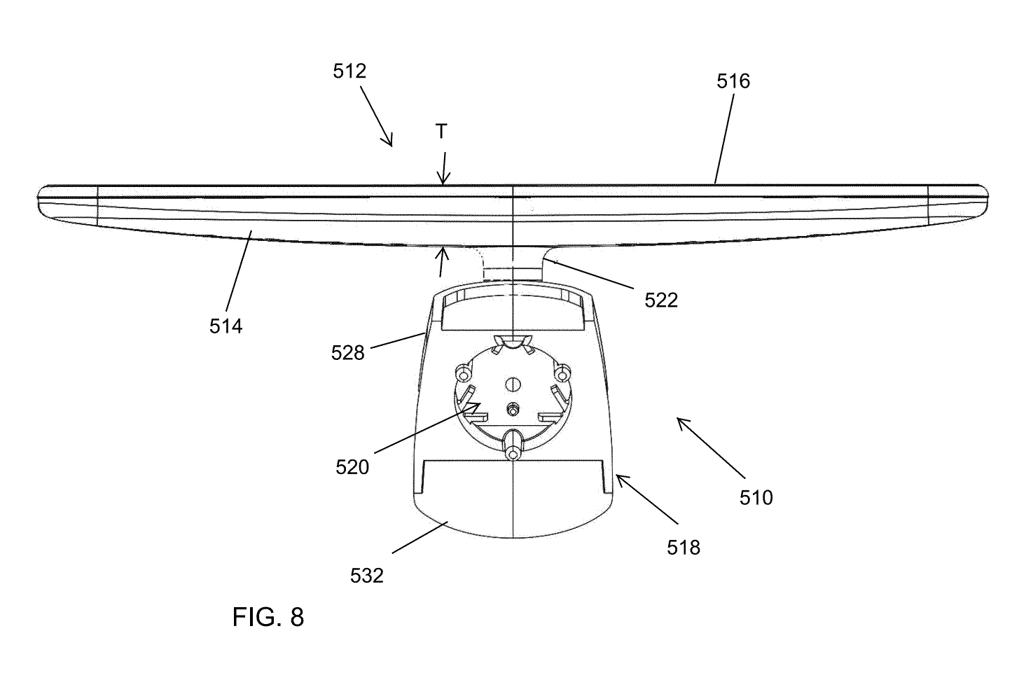

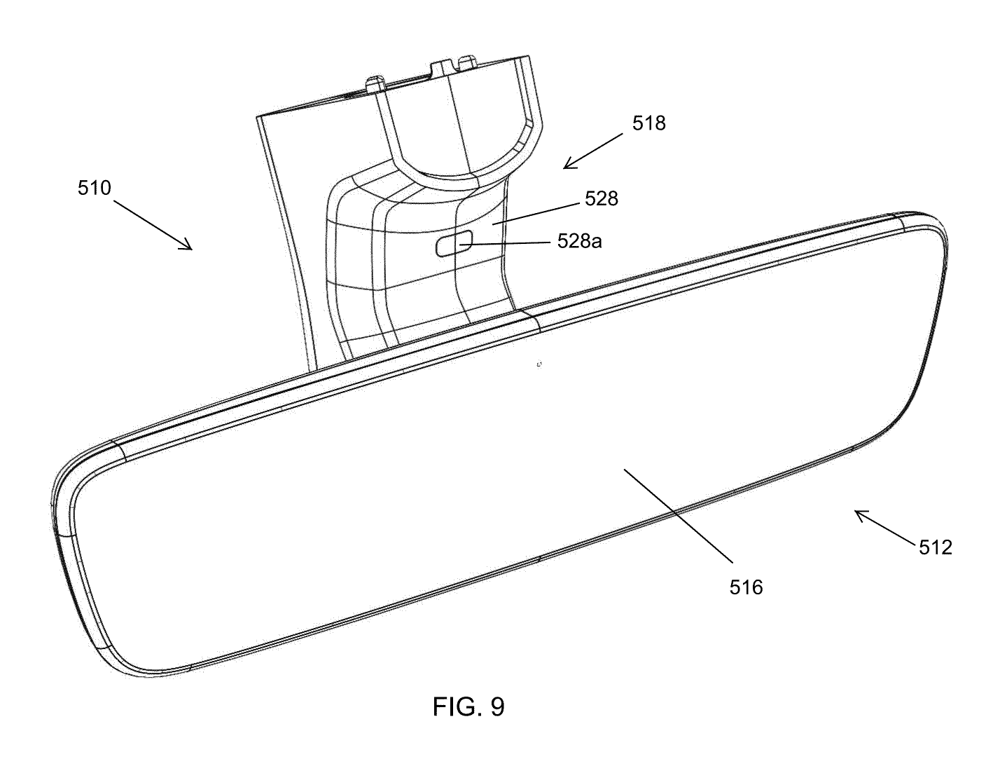

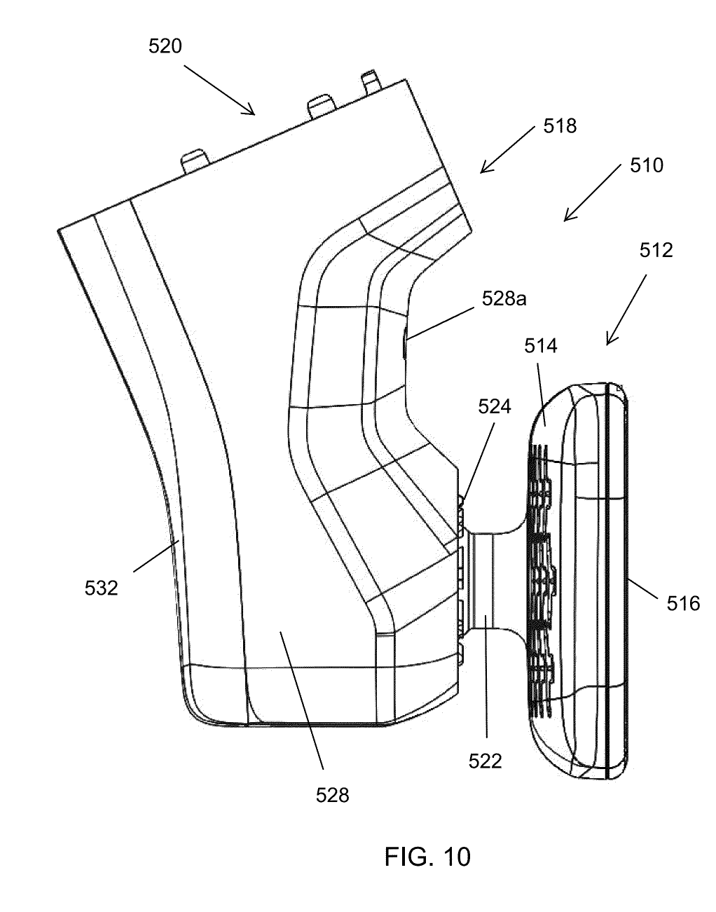

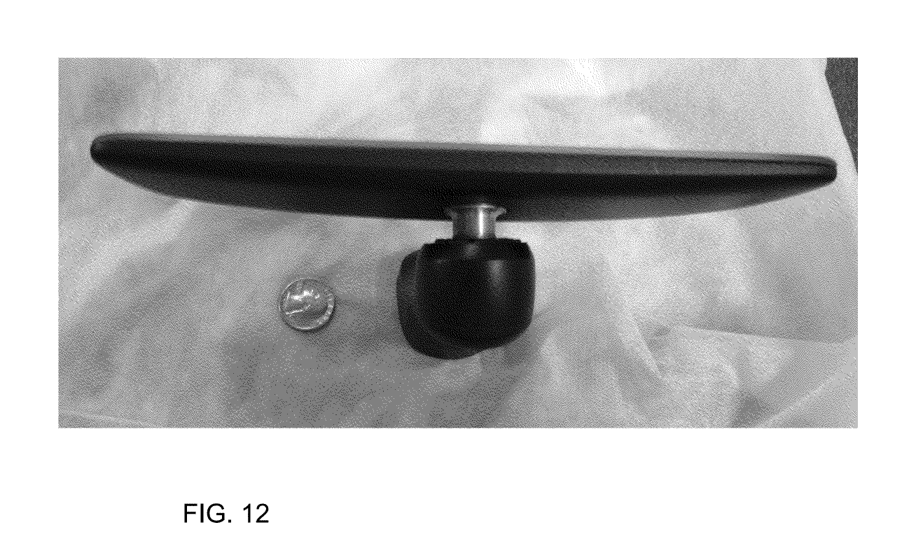

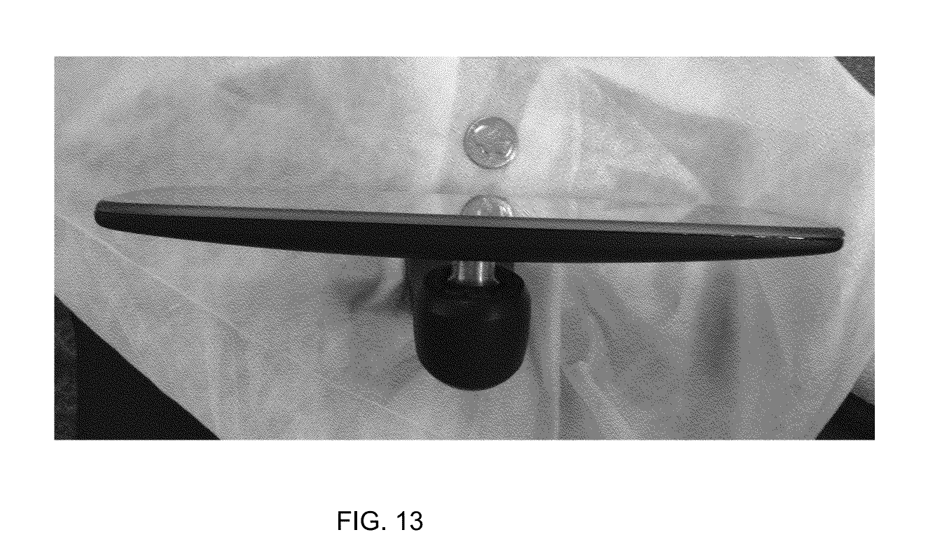

Optionally, an interior rearview mirror assembly of the present invention may provide a thin or substantially reduced size mirror head or mirror casing, such as for an electro-optic (such as electrochromic or the like) reflective element or such as for a prismatic reflective element. For example, and such as shown in FIGS. 6-11, a mirror head 512 of a mirror assembly 510 in accordance with the present invention may have a reduced or minimized housing depth, with the housing tapered at the ends. The mirror housing 514 and reflective element 516 thus may have a thin construction with tapered end or edge regions of the housing, such as in a similar manner as some tablets, such as an iPad® or the like, which may have a thickness dimension of between about 7.2 mm to about 9.4 mm. Thus, the mirror head of the present invention may have a reduced thickness dimension (the dimension between the front generally planar surface of the reflective element and the rear surface of the mirror casing at a generally central region of the mirror head), preferably less than about 20 mm, such as less than about 15 mm or less than about 10 mm, and may have a casing that as a generally flat central region with radiused or tapered perimeter edge regions. Thus, and such as shown in FIGS. 12 and 13, the thickness dimension (see, for example, the dimension “T” in FIG. 8) of the mirror head (between the front generally planar surface of the reflective element and the rear surface of the mirror casing at a generally central region of the mirror head) may have a dimension that is about the diameter of a U.S. Quarter (less than an inch or less than about 24.3 mm).

The mirror head 512 is pivotally mounted at a mounting structure or stay 518, which is configured to mount at an interior structure of a vehicle (such as at a header of a vehicle or such as at a windshield of a vehicle) via an attaching structure 520. The mirror head 512 includes a pivot element or ball member 522 that protrudes from the rear of the mirror casing 514, while the mounting structure 518 includes a pivot element or socket element 524 that pivotally receives the ball member 522 to pivotally attach the mirror head at the mounting structure or stay. The socket element 524 may comprise a separate piece that snap attaches or is otherwise fastened at the mounting stay 518 or optionally may be integrally molded with the mounting stay housing or insert molded in the mounting stay housing or structure. The ball member may comprise a metallic or plastic ball member and may be integrally molded with the mirror attachment plate or mirror casing or may be insert molded at the mirror casing.

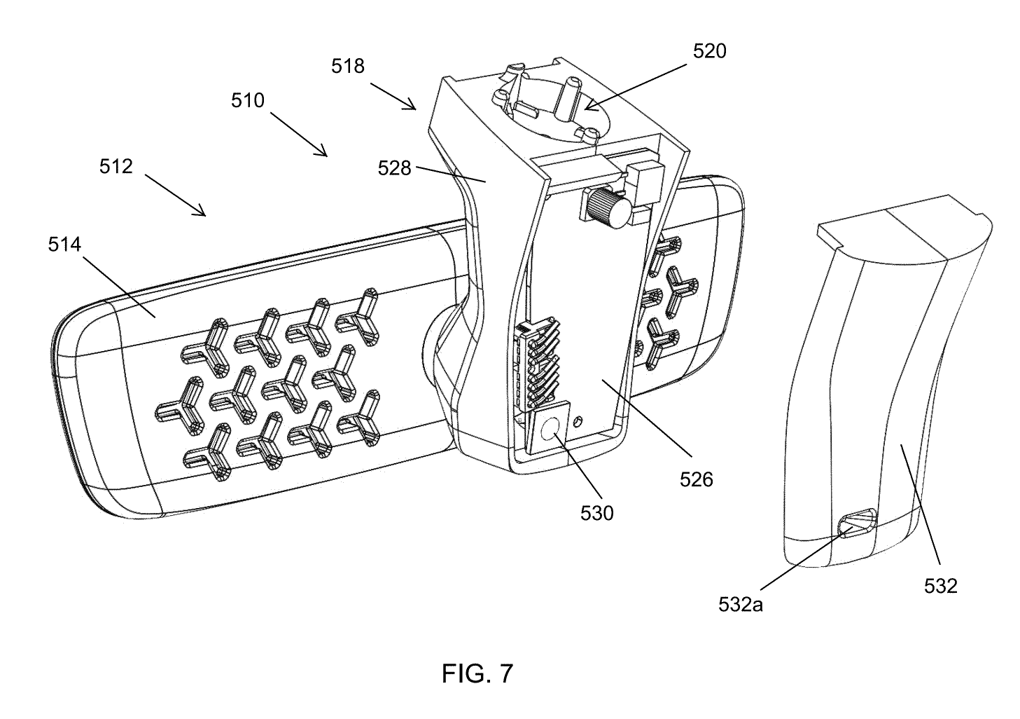

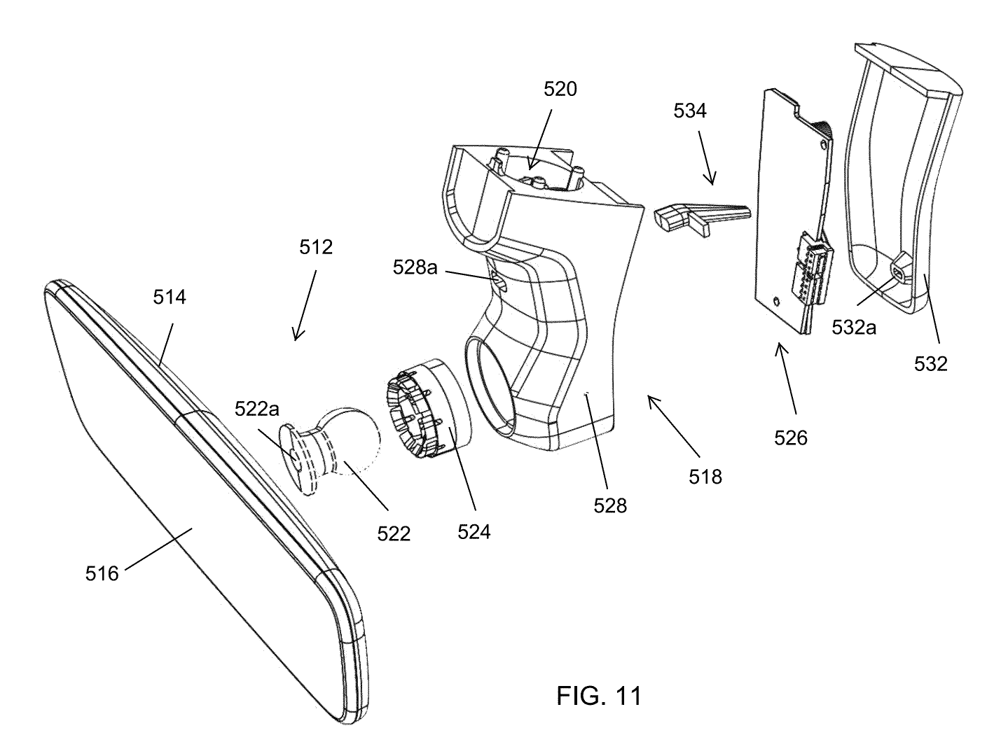

As shown in FIGS. 7 and 11, the thin mirror assembly 510 may have circuitry or a circuit element or circuit board 526 at or in the mounting arm or mounting structure or stay 518 of the mirror assembly (such as housed within a stay housing or casing 528), whereby a rearward viewing sensor or camera may be disposed at the rear of the reflective element (and optionally a forward viewing sensor or camera may be disposed at the rear of the reflective element for sensing forward of the reflective element and through the windshield of the vehicle equipped with the mirror assembly). For example, a forward viewing sensor 530 (FIG. 7) may be disposed at the circuit element 526 and may view forwardly through a cover 532 of the mounting structure or stay 518, such as through an aperture 532a formed through the cover 532, and/or a rearward viewing sensor 534 (FIG. 11) may be disposed at the circuit element 526 and may view forwardly through the housing or casing 528 of the mounting structure or stay 518, such as through an aperture 528a formed through the housing 528 (the rearward viewing sensor 534 is shown as a light pipe that will direct light received from a sensing end of the light pipe at the aperture 528a along the light pipe to a sensor or imager or imaging array disposed at the circuit board 526). The circuitry may electrically connect to a wiring harness of the vehicle and may power the sensors. The circuitry may also electrically connect to terminals of the electrochromic mirror reflective element or cell via one or more wires disposed within the mirror head and at the rear of the reflective element, with the wires passing through a passageway 522a (FIG. 11) formed through the ball member 522.

Thus, and such as shown in FIGS. 6-13, an interior rearview mirror assembly of the present invention may have an electrochromic reflective element with a circuit board and sensors disposed in a single-ball mirror mounting stay or structure, which is configured to attach at an interior structure of the vehicle. The sensors include a forward facing ambient light sensor that views through an aperture in the mounting structure and forwardly through the windshield of the vehicle when the mirror assembly is mounted in the vehicle. The sensors also include a rearward facing glare light sensor that views through an aperture in the mounting structure and views rearwardly over the reflective element and towards the rear window of the vehicle (so as to detect glare light emanating from vehicles following the subject or equipped vehicle). The sensors are disposed at a circuit element or circuit board disposed in the mounting structure, such as in a similar manner as described above.

As can be seen in FIGS. 6-13, the apertures are in the mount or stay, with the glare aperture established just above (or optionally below) the mirror reflective element edge so as to view rearwardly above or below the reflective element to capture or view glare lighting. The aperture in the mirror mount that faces forward allows for viewing forward by the ambient light sensor for sensing ambient light. The present invention thus provides for a much thinner packaging of the mirror head (as can be seen in FIGS. 12 and 13, the mirror head is as thin as or thinner than the diameter of a U.S. quarter), and allows for a reduction of a wiring harness by allowing for a direct connection to the PCB from the vehicle harness (such as at the headliner of the vehicle or the like), which is also a cost reduction feature. The mirror reflective element thus is simplified, thinner and lighter than previous mirror elements, including previous frameless mirror elements, and provides for creative styling to enhance the mirror's appearance.

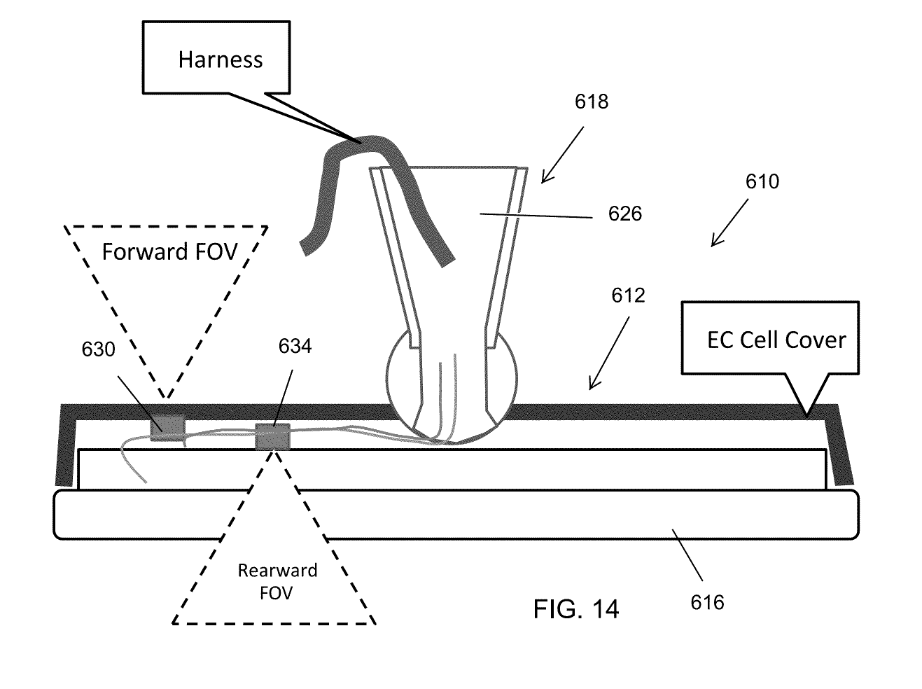

Optionally, and as shown in FIG. 14, a thin mirror assembly 610 may have circuitry or a circuit element or circuit board 626 in a mounting arm or mounting structure or stay 618 of the mirror assembly, whereby a rearward viewing sensor or camera 634 may be disposed at the rear of the reflective element 616 of the mirror head 612 (and optionally a forward viewing sensor or camera 630 may be disposed at the rear of the reflective element for sensing forward of the reflective element and through the windshield of the vehicle equipped with the mirror assembly). The circuitry may electrically connect to a wiring harness of the vehicle and may power the sensors and/or the EC cell via one or more wires disposed within the EC cell cover and at the rear of the reflective element. As shown in FIG. 14, the mirror casing or housing or EC cell cover may overlap or circumscribe the rear mirror substrate of the mirror reflective element, with the front mirror substrate being exposed, such as by utilizing aspects of U.S. Des. Pat. Nos. D633,423; D633,019; D638,761 and/or D647,017, and/or U.S. Publication No. US-2014-0313563, and/or International Publication Nos. WO 2010/124064; WO 2011/044312; WO 2012/051500; WO 2013/071070 and/or WO 2013/126719, which are all hereby incorporated herein by reference in their entireties.

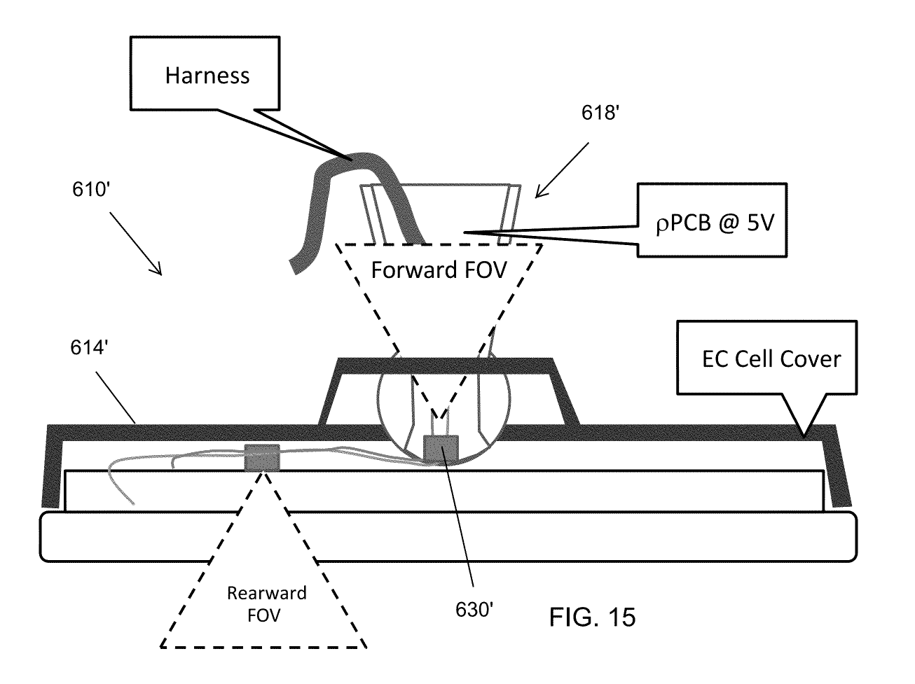

Optionally, and with reference to FIG. 15, the thin mirror assembly 610′ of the present invention may include a forward facing sensor or camera 630′ at the mounting arm or mounting structure 618′ of the mirror assembly, or at a generally central region of the EC cell cover or casing 614′. The generally central region of the EC cell cover may be enlarged to pivotally mount at a ball member of the mounting arm, or a stay cover or central cover portion may be provided to conceal and/or attach at the ball member of the mounting arm.

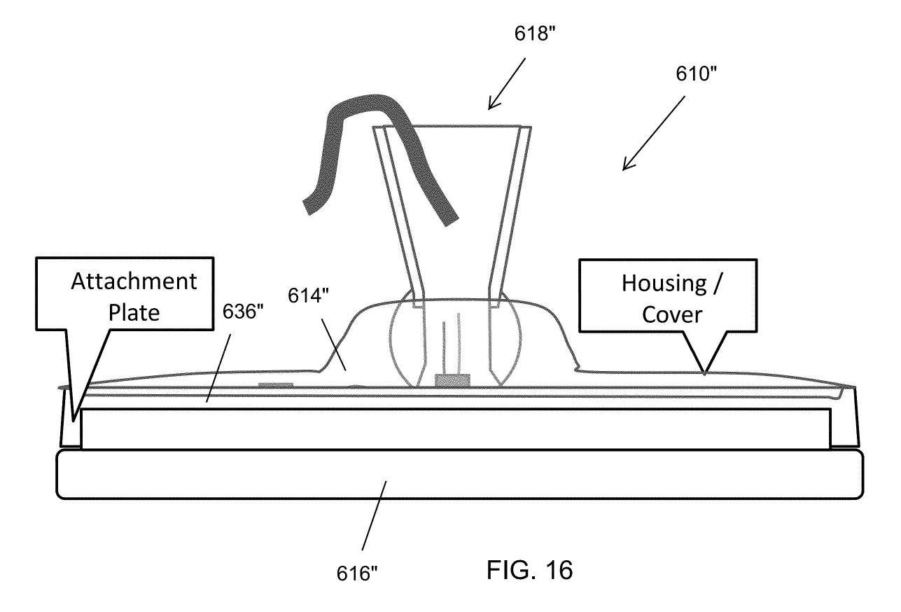

Optionally, and with reference to FIG. 16, a mirror assembly 610″ of the present invention may include an attachment plate 636″ (which may attach at and circumscribe the rear mirror substrate of the reflective element 616″, leaving the front mirror substrate exposed) having a generally planar rear portion along the rear surface of the rear mirror substrate, whereby a mirror housing or cover 614″ (such as a thin cover having tapered perimeter regions) may attach at the rear of the attachment plate, such as via a snap attachment or the like. As shown in FIG. 16, the mirror housing or cover may pivotally mount the mirror head at the ball member of the mounting arm or stay 618″ of the mirror assembly. In such a mirror construction, the sensors or cameras may be disposed at the mounting arm or at the central region of the mirror housing or cover.

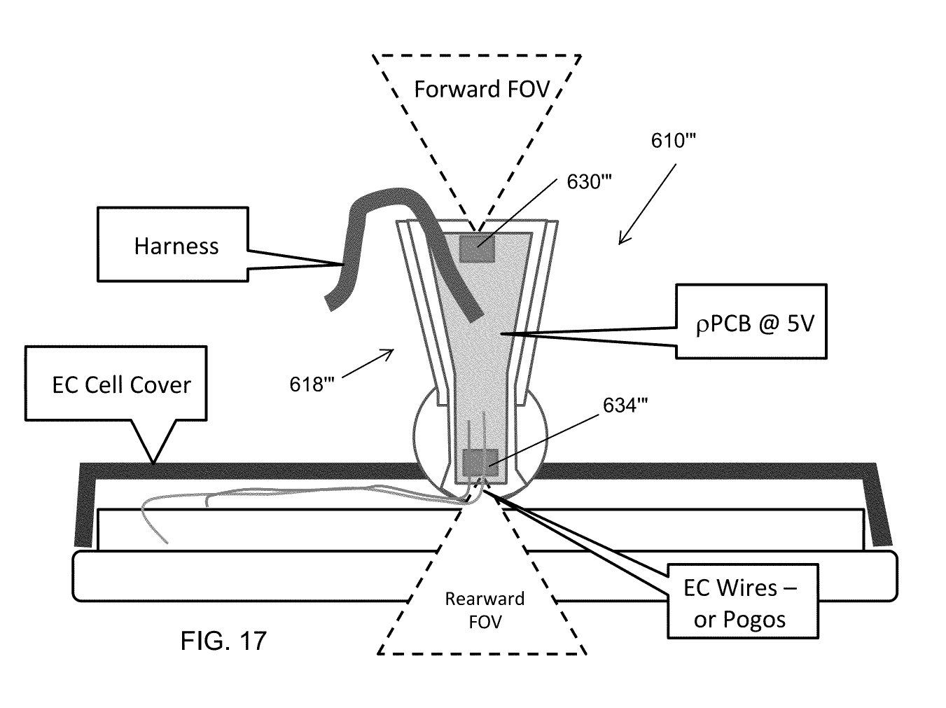

Optionally, and with reference to FIG. 17, a thin mirror assembly 610′″ of the present invention may include a forward facing sensor or camera 630′″ at a forward portion of the mounting arm or mounting structure 618′″ of the mirror assembly, and may include a rearward facing sensor or camera 634′″ at a rearward portion of the mounting arm. The electrically conductive coatings of the front and rear mirror substrates of the electrochromic reflective element may be powered via wires electrically connected between the circuit board at or in the mounting arm and busbars at the respective substrates or connected to the respective coatings.

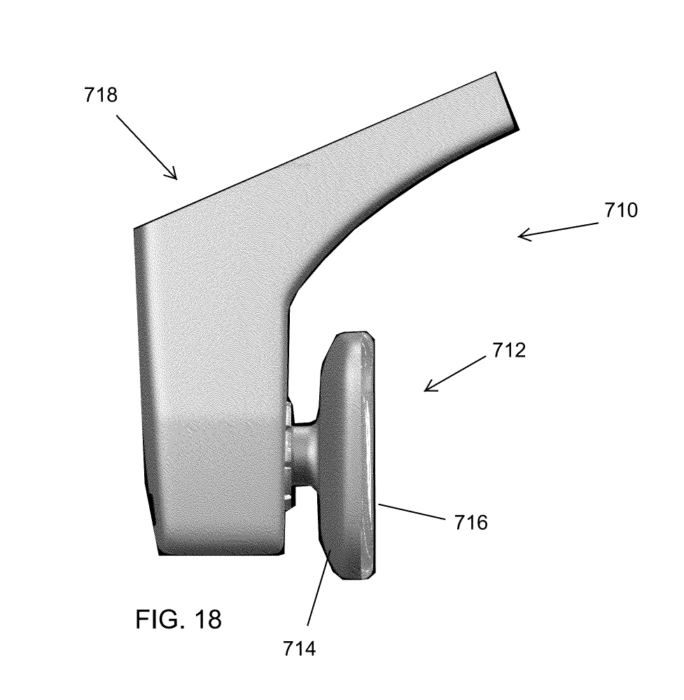

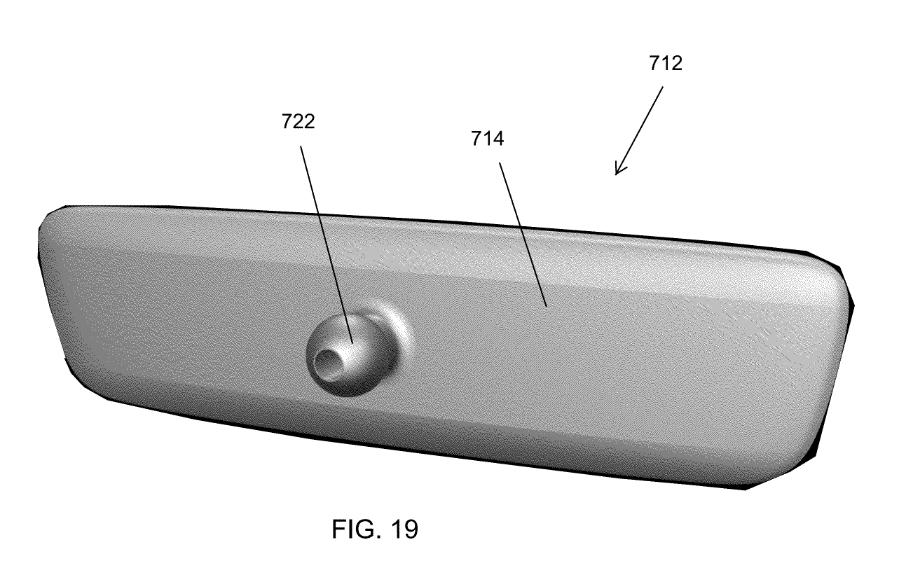

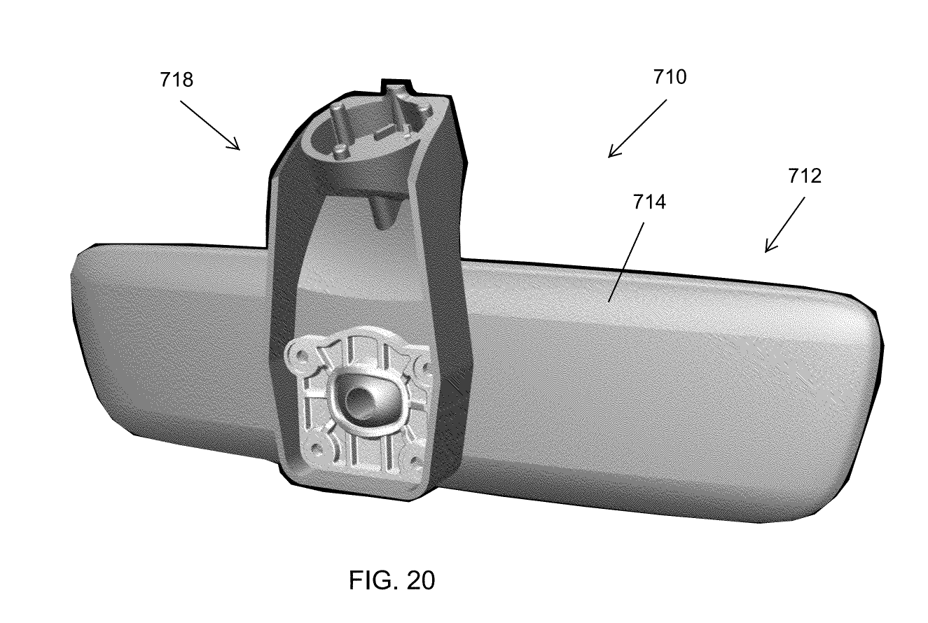

Thus, the present invention provides a thin EC interior rearview mirror assembly, where a circuit board may be disposed at or partially in the mounting structure or stay, so as to remove electrical content from the mirror head. For example, and as shown in FIGS. 18-22, a thin EC interior rearview mirror assembly 710 has a mirror head 712 that does not have control circuitry and the like disposed therein to allow for a thin mirror head. As shown in FIGS. 19 and 20, the mirror assembly may have a ball member 722 protruding from the mirror head (which may only include a reflective element 716 and casing 714), with provision for wires to pass through or by the ball member for electrical connection to the reflective element. The ball member may snap into or otherwise attach at a socket element (FIG. 20) of the mounting structure (such as a metallic socket element attached or fastened to the plastic mounting structure or stay 718, with the ball member being received through an aperture in the mounting structure and in the socket element) to pivotally mount the mirror head at the mounting structure or stay 718.

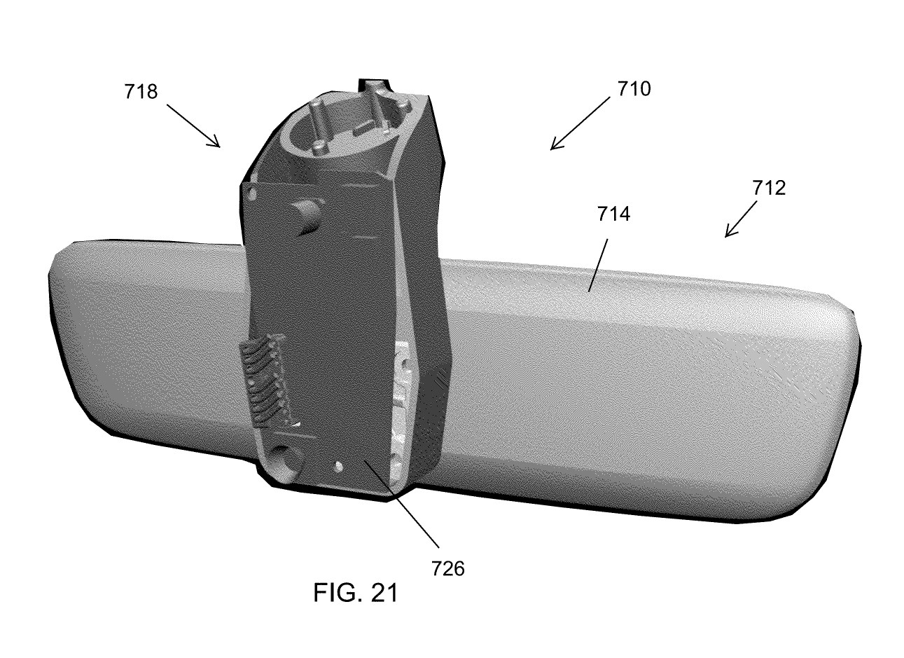

As shown in FIG. 21, a circuit board 726 (such as a printed circuit board or flexible printed circuit board) is disposed at the mirror mounting structure or stay, such as along a generally vertical portion of the stay. The circuit element includes circuitry, such as EC control circuitry and the like, and is electrically connected to the terminals or busbars of the EC reflective element of the mirror head, such as via wires that pass through the socket element and ball member and into the mirror head. The circuit element may include other circuitry and may include one or more sensors (such as a camera or an ambient light sensor and/or a glare light sensor) and may include a multi-pin electrical connector for electrically connecting the circuitry of the circuit element to a wiring harness of the vehicle when the mounting structure is mounted at an interior portion of a vehicle.

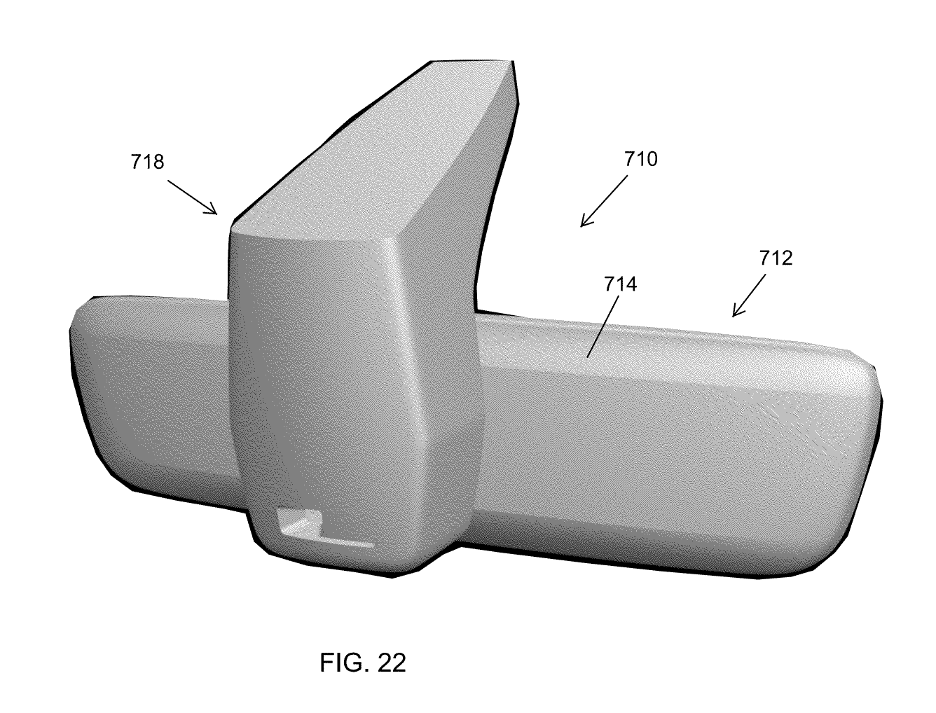

As shown in FIG. 22, a mirror stay casing or housing is disposed over and around the mirror stay to encase the mounting structure and circuit element (and electrical connectors and wiring harness) therein. The casing or housing may be attached at the mounting structure after the mirror mounting structure is attached at the interior portion of the vehicle and after the vehicle wiring harness is electrically connected at the multi-pin connector of the circuit element. The casing or housing may snap attach at the mounting structure or may otherwise attach in a manner that substantially encases the mounting structure and circuit element.

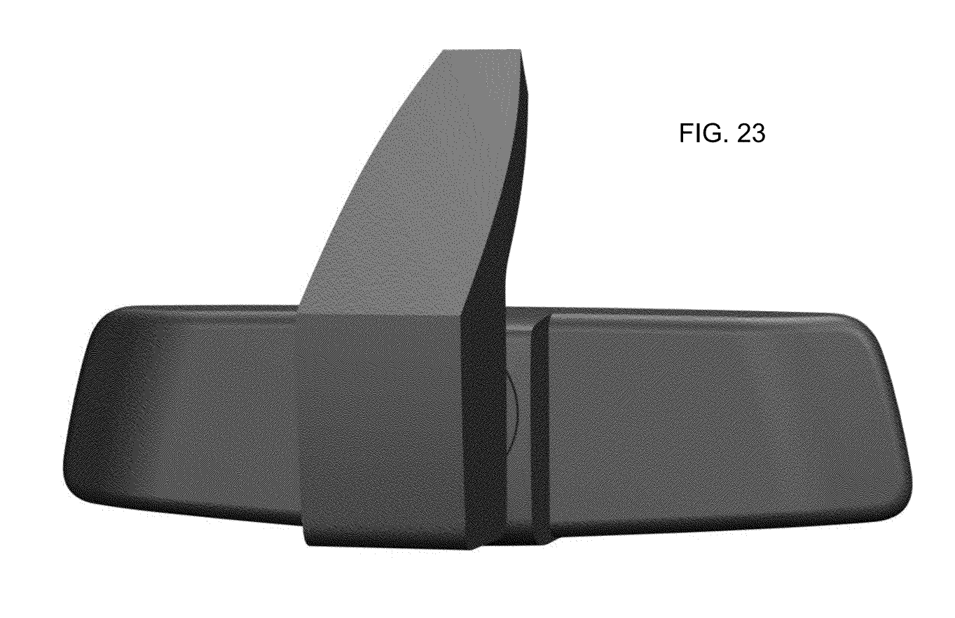

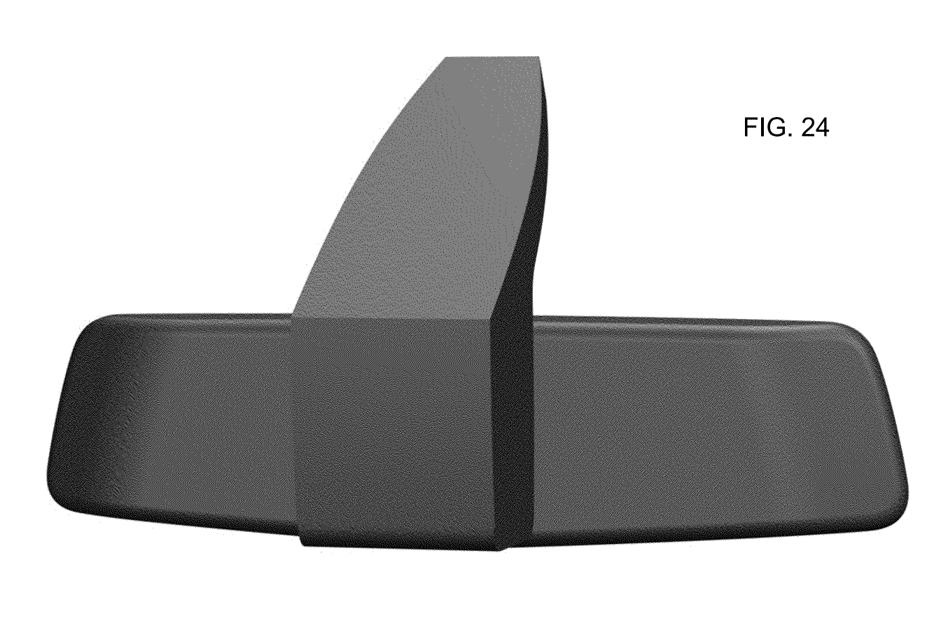

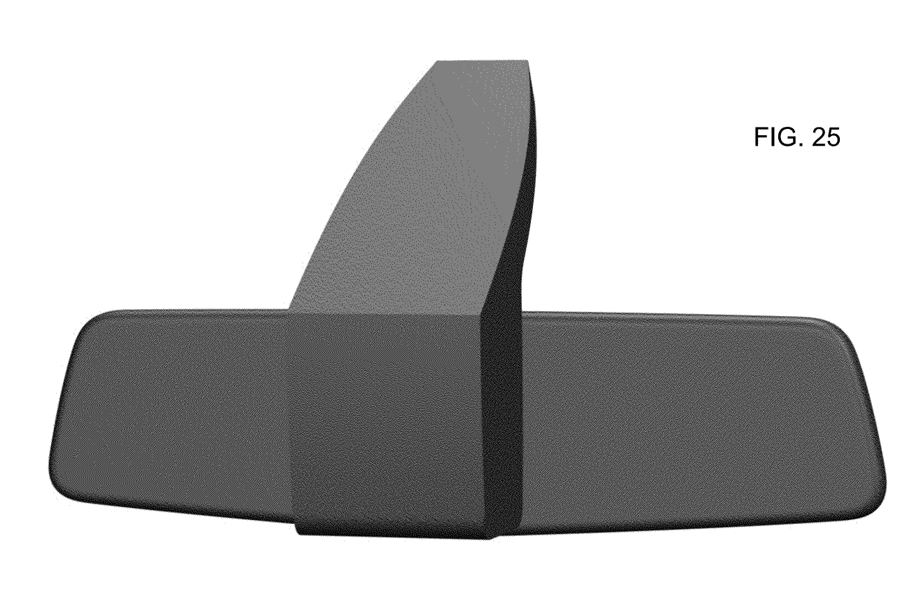

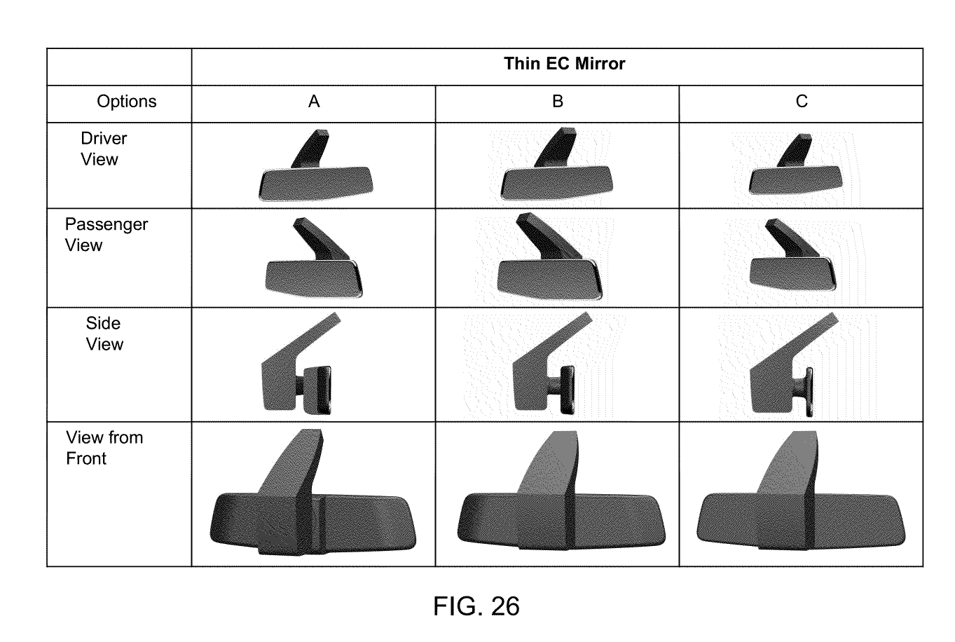

Thus, and such as also shown in FIGS. 23-26, a mirror head in accordance with the present invention may have a reduced or minimized housing depth, with the housing tapered at the ends. The mirror housing and reflective element thus may have a thin construction with tapered end or edge regions of the housing, such as in a similar manner as some tablets, such as an iPad® or the like, which may have a thickness of between about 7.2 mm to about 9.4 mm. Thus, the mirror head of the present invention may have a reduced thickness (the dimension between the front generally planar surface of the reflective element and the rear surface of the mirror casing at a generally central region of the mirror head), preferably less than about 20 mm, such as less than about 15 mm or less than about 10 mm, and may have a casing that as a generally flat central region with radiused or tapered perimeter edge regions.

Thus, the circuit board is disposed outside of the mirror head or reflective element assembly, and is mounted in the single ball mirror mounting structure or stay. Such a configuration eliminates a wiring harness that would extend from the stay to the mirror head (with the exception that two wires may be routed through the single ball for electrical connection to the electrochromic mirror reflective element or cell). The sensors view out from behind the stay cover or mount cover and through respective apertures in the cover. Optionally, one or both sensors or sensing functions (glare light sensing and ambient light sensing) may be integrated in a respective camera (such as a rearward viewing camera and a forward viewing camera).

As discussed above, the mirror assembly may comprise an electro-optic or electrochromic mirror assembly that includes an electro-optic or electrochromic reflective element. The perimeter edges of the reflective element may be encased or encompassed by the perimeter element or portion of the bezel portion to conceal and contain and envelop the perimeter edges of the substrates and the perimeter seal disposed therebetween. The electrochromic mirror element of the electrochromic mirror assembly may utilize the principles disclosed in commonly assigned U.S. Pat. Nos. 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, and/or PCT Application No. PCT/US2010/029173, filed Mar. 30, 2010, which are hereby incorporated herein by reference in their entireties.

Although shown as an electrochromic mirror application, it is envisioned that the mirror assembly may comprise a prismatic reflective element, while remaining within the spirit and scope of the present invention. The prismatic mirror assembly may be mounted or attached at an interior portion of a vehicle (such as at an interior surface of a vehicle windshield) via the mounting means described above, and the reflective element may be toggled or flipped or adjusted between its daytime reflectivity position and its nighttime reflectivity position via any suitable toggle means, such as by utilizing aspects of the mirror assemblies described in U.S. Pat. Nos. 6,318,870 and/or 7,249,860, and/or U.S. Publication No. US-2010-0085653, which are hereby incorporated herein by reference in their entireties. Optionally, for example, the interior rearview mirror assembly may comprise a prismatic mirror assembly, such as the types described in U.S. Pat. Nos. 7,289,037; 7,249,860; 6,318,870; 6,598,980; 5,327,288; 4,948,242; 4,826,289; 4,436,371 and 4,435,042, which are hereby incorporated herein by reference in their entireties. Optionally, the prismatic reflective element may comprise a conventional prismatic reflective element or prism or may comprise a prismatic reflective element of the types described in U.S. Pat. Nos. 7,420,756; 7,289,037; 7,274,501; 7,249,860; 7,338,177 and/or 7,255,451, which are all hereby incorporated herein by reference in their entireties, without affecting the scope of the present invention. A variety of mirror accessories and constructions are known in the art, such as those disclosed in U.S. Pat. Nos. 5,555,136; 5,582,383; 5,680,263; 5,984,482; 6,227,675; 6,229,319 and/or 6,315,421 (which are hereby incorporated herein by reference in their entireties), that can benefit from the present invention.

Optionally, the reflective element may include an opaque or substantially opaque or hiding perimeter layer or coating or band disposed around a perimeter edge region of the front substrate (such as at a perimeter region of the rear or second surface of the front substrate) to conceal or hide or the perimeter seal from viewing by the driver of the vehicle when the mirror assembly is normally mounted in the vehicle. Such a hiding layer or perimeter band may be reflective or not reflective and may utilize aspects of the perimeter bands and mirror assemblies described in U.S. Pat. Nos. 5,066,112; 7,626,749; 7,274,501; 7,184,190 and/or 7,255,451, and/or International Publication Nos. WO 2010/124064 and/or WO 2011/044312, and/or U.S. Pat. Pub. No. US-2006-0061008, which are all hereby incorporated herein by reference in their entireties. Optionally, the perimeter band may comprise a chrome/chromium coating or metallic coating and/or may comprise a chrome/chromium or metallic coating that has a reduced reflectance, such as by using an oxidized chrome coating or chromium oxide coating or “black chrome” coating or the like (such as by utilizing aspects of the mirror assemblies described in U.S. Pat. Nos. 7,184,190 and/or 7,255,451, which are hereby incorporated herein by reference in their entireties). Optionally, other opaque or substantially opaque coatings or bands may be implemented while remaining within the spirit and scope of the present invention.

Optionally, the interior rearview mirror assembly may include circuitry therein (such as at a printed circuit board or the like disposed within the mirror casing, and electrical connection to the circuitry may be made via an electrical lead or connector of a wiring harness of the vehicle. Optionally, the electrical connector may be received through the mirror casing and through an aperture established through the toggle element, such as by utilizing aspects of the mirror assemblies described in U.S. Pat. No. 5,798,688 and/or U.S. Publication No. US-2010-0085653, which are hereby incorporated herein by reference in their entireties.

The mirror assembly may include user actuatable inputs operable to control any of the accessories of or associated with the mirror assembly and/or an accessory module or the like. For example, the mirror assembly may include touch sensitive elements or touch sensors or proximity sensors, such as the types of touch sensitive elements described in U.S. Pat. Nos. 5,594,222; 6,001,486; 6,310,611; 6,320,282; 6,627,918; 7,224,324 and/or 7,253,723, and/or International Publication Nos. WO 2012/051500 and/or WO 2013/071070, which are hereby incorporated herein by reference in their entireties, or such as proximity sensors of the types described in U.S. Pat. Nos. 7,224,324; 7,249,860 and/or 7,446,924, and/or International Publication No. WO 2004/058540, which are hereby incorporated herein by reference in their entireties, or such as membrane type switches, such as described in U.S. Pat. No. 7,360,932, which is hereby incorporated herein by reference in its entirety, or such as detectors and the like, such as the types disclosed in U.S. Pat. Nos. 7,255,541; 6,504,531; 6,501,465; 6,492,980; 6,452,479; 6,437,258 and/or 6,369,804, which are hereby incorporated herein by reference in their entireties, and/or the like, while remaining within the spirit and scope of the present invention.

Optionally, the user inputs or buttons may comprise user inputs for a garage door opening system, such as a vehicle based garage door opening system of the types described in U.S. Pat. Nos. 6,396,408; 6,362,771; 7,023,322 and/or 5,798,688, which are hereby incorporated herein by reference in their entireties. Optionally, the user inputs may also or otherwise comprise user inputs for a telematics system of the vehicle, such as, for example, an ONSTAR® system as found in General Motors vehicles and/or such as described in U.S. Pat. Nos. 4,862,594; 4,937,945; 5,131,154; 5,255,442; 5,632,092; 5,798,688; 5,971,552; 5,924,212; 6,243,003; 6,278,377; 6,420,975; 6,477,464; 6,946,978; 7,308,341; 7,167,796; 7,004,593; 7,657,052 and/or 6,678,614, which are all hereby incorporated herein by reference in their entireties.

Optionally, the mirror assembly may include one or more other displays, such as the types disclosed in U.S. Pat. Nos. 5,530,240 and/or 6,329,925, which are hereby incorporated herein by reference in their entireties, and/or display-on-demand transflective type displays, and/or video displays or display screens, such as the types disclosed in U.S. Pat. Nos. 8,890,955; 7,855,755; 7,338,177; 7,274,501; 7,255,451; 7,195,381; 7,184,190; 7,046,448; 5,668,663; 5,724,187; 5,530,240; 6,329,925; 6,690,268; 7,734,392; 6,902,284; 6,428,172; 6,420,975; 5,416,313; 5,285,060; 5,193,029 and/or 4,793,690, and/or U.S. Pat. Pub. Nos. US-2003-0007261; US-2006-0061008; US-2006-0050018; US-2009-0015736; US-2009-0015736; US-2010-0097469 and/or US-2012-0154591, which are all hereby incorporated herein by reference in their entireties.

The video display screen may be controlled or operable in response to an input or signal, such as a signal received from one or more cameras or image sensors of the vehicle, such as a video camera or sensor, such as a CMOS imaging array sensor, a CCD sensor or the like, and image processors or image processing techniques, such as utilizing aspects of the cameras and image processors described U.S. Pat. Nos. 5,550,677; 5,670,935; 5,760,962; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606 and/or 7,720,580, and/or U.S. Pat. Pub. Nos. US-2006-0171704; US-2009-0244361 and/or US-2010-0214791, and/or International Publication Nos. WO 2009/046268 and/or WO 2009/036176, which are all hereby incorporated herein by reference in their entireties, or from one or more imaging systems of the vehicle, such as a reverse or backup aid system, such as a rearwardly directed vehicle vision system utilizing principles disclosed in U.S. Pat. Nos. 5,550,677; 5,760,962; 5,670,935; 6,201,642; 6,396,397; 6,498,620; 6,717,610 and/or 6,757,109, which are hereby incorporated herein by reference in their entireties, a trailer hitching aid or tow check system, such as the type disclosed in U.S. Pat. No. 7,005,974, which is hereby incorporated herein by reference in its entirety, a cabin viewing or monitoring device or system, such as a baby viewing or rear seat viewing camera or device or system or the like, such as disclosed in U.S. Pat. Nos. 5,877,897 and/or 6,690,268, which are hereby incorporated herein by reference in their entireties, a video communication device or system, such as disclosed in U.S. Pat. No. 6,690,268, which is hereby incorporated herein by reference in its entirety, and/or the like. The imaging sensor or camera may be activated and the display screen may be activated in response to the vehicle shifting into reverse, such that the display screen is viewable by the driver and is displaying an image of the rearward scene while the driver is reversing the vehicle. It is envisioned that an image processor or controller (such as an EyeQ™ image processing chip available from Mobileye Vision Technologies Ltd. of Jerusalem, Israel, and such as an image processor of the types described in International Pub. No. WO/2010/099416, which is hereby incorporated herein by reference in its entirety) may process image data captured by the rearward facing camera to assess glare lighting conditions (such as to detect headlights of following vehicles that may cause glare at the interior and/or exterior rearview mirror assemblies of the equipped vehicle), and the controller may adjust or control the dimming of the electro-optic mirror assembly or assemblies of the equipped vehicle responsive to such image processing.

Optionally, the mirror assembly may include one or more other accessories at or within the mirror casing, such as one or more electrical or electronic devices or accessories, such as antennas, including global positioning system (GPS) or cellular phone antennas, such as disclosed in U.S. Pat. No. 5,971,552, a communication module, such as disclosed in U.S. Pat. No. 5,798,688, a blind spot detection system, such as disclosed in U.S. Pat. Nos. 5,929,786 and/or 5,786,772, transmitters and/or receivers, such as a garage door opener or the like, a digital network, such as described in U.S. Pat. No. 5,798,575, a high/low headlamp controller, such as disclosed in U.S. Pat. Nos. 5,796,094 and/or 5,715,093, a memory mirror system, such as disclosed in U.S. Pat. No. 5,796,176, a hands-free phone attachment, a video device for internal cabin surveillance and/or video telephone function, such as disclosed in U.S. Pat. Nos. 5,760,962 and/or 5,877,897, a remote keyless entry receiver, lights, such as map reading lights or one or more other lights or illumination sources, such as disclosed in U.S. Pat. Nos. 6,690,268; 5,938,321; 5,813,745; 5,820,245; 5,673,994; 5,649,756; 5,178,448; 5,671,996; 4,646,210; 4,733,336; 4,807,096; 6,042,253; 5,669,698; 7,195,381; 6,971,775 and/or 7,249,860, microphones, such as disclosed in U.S. Pat. Nos. 7,657,052; 6,243,003; 6,278,377 and/or 6,420,975, speakers, antennas, including global positioning system (GPS) or cellular phone antennas, such as disclosed in U.S. Pat. No. 5,971,552, a communication module, such as disclosed in U.S. Pat. No. 5,798,688, a voice recorder, a blind spot detection system, such as disclosed in U.S. Pat. Nos. 7,720,580; 7,038,577; 6,882,287; 5,929,786 and/or 5,786,772, transmitters and/or receivers, such as for a garage door opener or a vehicle door unlocking system or the like (such as a remote keyless entry system), a digital network, such as described in U.S. Pat. No. 5,798,575, a high/low headlamp controller, such as a camera-based headlamp control, such as disclosed in U.S. Pat. Nos. 5,796,094 and/or 5,715,093, a memory mirror system, such as disclosed in U.S. Pat. No. 5,796,176, a hands-free phone attachment, an imaging system or components or circuitry or display thereof, such as an imaging and/or display system of the types described in U.S. Pat. Nos. 7,400,435; 7,526,103; 6,690,268 and/or 6,847,487, and/or U.S. Pat. Pub. No. US-2006-0125919, a video device for internal cabin surveillance (such as for sleep detection or driver drowsiness detection or the like) and/or video telephone function, such as disclosed in U.S. Pat. Nos. 5,760,962 and/or 5,877,897, a remote keyless entry receiver, a seat occupancy detector, a remote starter control, a yaw sensor, a clock, a carbon monoxide detector, status displays, such as displays that display a status of a door of the vehicle, a transmission selection (4wd/2wd or traction control (TCS) or the like), an antilock braking system, a road condition (that may warn the driver of icy road conditions) and/or the like, a trip computer, a tire pressure monitoring system (TPMS) receiver (such as described in U.S. Pat. Nos. 6,124,647; 6,294,989; 6,445,287; 6,472,979; 6,731,205 and/or 7,423,522, and/or an ONSTAR® system, a compass, such as disclosed in U.S. Pat. Nos. 5,924,212; 4,862,594; 4,937,945; 5,131,154; 5,255,442 and/or 5,632,092, and/or any other accessory or circuitry or the like (with all of the above-referenced patents and publications being commonly assigned and being hereby incorporated herein by reference in their entireties).

Optionally, the mirror assembly may include other electrically operated or powered accessories, such as a compass sensor and compass display. The user inputs may also or otherwise function to activate and deactivate a display or function or accessory, and/or may activate/deactivate and/or commence a calibration of a compass system of the mirror assembly and/or vehicle. The compass system may include compass sensors and circuitry within the mirror assembly or within a compass pod or module at or near or associated with the mirror assembly. Such a compass sensor and circuitry for the compass system that detects and displays the vehicle directional heading to a driver of the vehicle may comprise any suitable compass sensor and/or circuitry, such as a compass system and compass circuitry that utilizes aspects of the compass systems described in U.S. Pat. Nos. 7,329,013; 7,289,037; 7,249,860; 7,004,593; 6,928,366; 6,642,851; 6,140,933; 4,546,551; 4,862,594; 4,937,945; 5,699,044; 4,953,305; 5,131,154; 5,255,442; 5,576,687; 5,632,092; 5,677,851; 5,708,410; 5,737,226; 5,802,727; 5,878,370; 5,924,212; 6,087,953; 6,173,508; 6,222,460 and/or 6,513,252, and/or U.S. Pat. Pub. No. US-2006-0061008, which are all hereby incorporated herein by reference in their entireties. The compass circuitry may include compass sensors, such as a magneto-responsive sensor, such as a magneto-resistive sensor, a magneto-capacitive sensor, a Hall sensor, a magneto-inductive sensor, a flux-gate sensor or the like. Optionally, an integrated automotive “compass-on-a-chip” may be disposed in a cavity of the mounting base of the mirror (or within the mirror housing or in an attachment to the mirror mount or elsewhere within the mirror assembly such as to the rear of the video screen or to the rear of the mirror reflective element) and may comprise at least two sensor elements (such as magneto-responsive sensor elements, or a Hall effect sensor or multiple Hall effect sensors), associated A/D and D/A converters, associated microprocessor(s) and memory, associated signal processing and filtering, associated display driver and associated LIN/CAN BUS interface and the like, all (or a sub-set thereof) created or disposed or commonly established onto a semiconductor chip surface/substrate or silicon substrate, such as utilizing CMOS technology and/or fabrication techniques as known in the semiconductor manufacturing arts, and constituting an application specific integrated chip (“ASIC”), such as utilizing principles described in U.S. Pat. Nos. 7,815,326; 7,004,593 and/or 7,329,013, which are hereby incorporated herein by reference in their entireties, and/or such as by utilizing aspects of an EC driver-on-a-chip such as described in U.S. Pat. No. 7,480,149, which is hereby incorporated herein by reference in its entirety.

The mirror assembly may comprise or utilize aspects of other types of casings or the like, such as described in U.S. Pat. Nos. 7,338,177; 7,289,037; 7,249,860; 6,439,755; 4,826,289 and/or 6,501,387, which are all hereby incorporated herein by reference in their entireties, without affecting the scope of the present invention. For example, the mirror assembly may utilize aspects of the flush or frameless or bezelless reflective elements described in U.S. Pat. Nos. 7,626,749; 7,360,932; 7,289,037; 7,255,451; 7,274,501 and/or 7,184,190, which are all hereby incorporated herein by reference in their entireties.

Optionally, the mirror assembly may comprise a modular mirror construction, and may include back housing portions or the like, such as cap portions of the types described in U.S. Pat. No. 7,289,037, which is hereby incorporated herein by reference in its entirety. A display screen may be provided as a modular display screen and may be mountable or installable in the appropriate or suitable mirror casing to provide a modular mirror assembly and display screen. For example, a rear casing or cap portion may include the display screen module including the associated components, such as the rails and motor and the like for a video slideout module (such as by utilizing aspects of the video mirrors described in U.S. Pat. Nos. 7,855,755; 7,370,983 and/or 6,690,268, which are hereby incorporated herein by reference in their entireties), and may be attachable to a reflective element and/or mirror casing to assemble the modular mirror assembly. The display screen module thus may be provided as an optional component or accessory for a vehicle, and may be readily assembled to a common reflective element and/or mirror casing of the mirror assembly.

Optionally, the mirror casing and/or reflective element may include customized or personalized viewable characteristics, such as color or symbols or indicia selected by the vehicle manufacturer or owner of the vehicle, such as the customization characteristics described in U.S. Pat. Nos. 7,626,749; 7,255,451 and/or 7,289,037, which are hereby incorporated herein by reference in their entireties.

Optionally, the mirror assembly and/or any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742 and/or 6,124,886, and/or U.S. Pat. Pub. No. US-2006-0050018, which are hereby incorporated herein by reference in their entireties.

Optionally, the mirror assembly (such as at the mounting base, which may be fixed relative to the vehicle windshield) may include an imaging sensor (such as a forward facing imaging sensor or camera that has a forward field of view through the vehicle windshield) that may be part of or may provide an image output for a vehicle vision system, such as a headlamp control system or lane departure warning system or object detection system or other vehicle vision system or the like, and may utilize aspects of various imaging sensors or imaging array sensors or cameras or the like, such as a CMOS imaging array sensor, a CCD sensor or other sensors or the like, such as the types described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, which are hereby incorporated herein by reference in their entireties.

Optionally, the accessory or accessories, such as those described above, may be positioned at or within the mirror casing and/or mirror cap portion or the like, and may be included on or integrated in a printed circuit board positioned within the mirror casing and/or cap portion, such as along a rear surface of the reflective element or elsewhere within a cavity defined by the casing, without affecting the scope of the present invention. The user actuatable inputs and/or touch sensors and/or proximity sensors and displays described above may be actuatable to control and/or adjust the accessories of the mirror assembly/system and/or overhead console and/or accessory module and/or vehicle. The connection or link between the controls and the display screen device and/or the navigation system and/or other systems and accessories of the mirror system may be provided via vehicle electronic or communication systems and the like, and may be connected via various protocols or nodes, such as BLUETOOTH®, SCP, UBP, J1850, CAN J2284, Fire Wire 1394, MOST, LIN, FlexRay™, Byte Flight and/or the like, or other vehicle-based or in-vehicle communication links or systems (such as WIFI and/or IRDA) and/or the like, or via VHF or UHF or other wireless transmission formats, depending on the particular application of the mirror/accessory system and the vehicle. Optionally, the connections or links may be provided via various wireless connectivity or links, without affecting the scope of the present invention.

Changes and modifications in the specifically described embodiments may be carried out without departing from the principles of the present invention, which is intended to be limited only by the scope of the appended claims as interpreted according to the principles of patent law.

1. A visor assembly for a vehicle, said visor assembly comprising:
a visor element configured to pivotally attach at an interior portion of a vehicle, wherein said visor element, when attached at the interior portion of the vehicle, is pivotable between a non-use position, where the visor is disposed along a roof of the vehicle, and a use position, where the visor element is disposed at least partially along the windshield of the vehicle;
a vanity mirror reflective element comprising a glass mirror substrate and a mirror reflector coating established at a surface of said vanity mirror reflective element;
wherein said vanity mirror reflective element is disposed at said visor element of the vehicle so as to be viewable by a driver of the vehicle when said visor element is pivoted to the use position; and
wherein said glass mirror substrate has a rounded perimeter edge that is exposed at said visor element and is viewable by the driver of the vehicle when said visor element is pivotally attached at the interior portion of the vehicle and in the use position.

2. The visor assembly of claim 1, comprising at least one illumination source disposed behind said vanity mirror reflective element and, when said at least one illumination source is activated, illumination emitted by said at least one illumination source is viewable through said vanity mirror reflective element.

3. The visor assembly of claim 2, comprising a user input for controlling said at least one illumination source.

4. The visor assembly of claim 3, wherein said user input comprises a touch sensor disposed behind said glass mirror substrate and operable to sense a touch or proximity of a user's finger at said glass mirror substrate.

5. The visor assembly of claim 4, wherein said user input is operable to adjust an intensity of said at least one illumination source responsive to a determined movement of the user's finger across a portion of said glass mirror substrate.

6. The visor assembly of claim 1, wherein said glass mirror substrate is partially recessed at said visor element.

7. The visor assembly of claim 1, wherein said rounded perimeter edge protrudes at least partially from a surface of said visor element.

8. The visor assembly of claim 1, wherein said rounded perimeter edge of said glass mirror substrate has a polished water-clear surface finish.

9. The visor assembly of claim 1, wherein said rounded perimeter edge of said glass mirror substrate has a frosted or non-water-clear surface finish.

10. An interior rearview mirror assembly for a vehicle, said interior rearview mirror assembly comprising:
a mirror mount configured to attach at an interior portion of a vehicle equipped with said interior rearview mirror assembly;
a mirror head pivotally mounted at a pivot element of said mirror mount, said mirror head comprising a mirror casing and a mirror reflective element;
wherein said mirror head comprises a reduced profile mirror casing having a thickness dimension between a front generally planar surface of said mirror reflective element and a rear surface of a generally central region of said mirror casing, and wherein said thickness dimension is less than about 20 mm;
a circuit board having circuitry associated with at least one accessory of said mirror head of interior rearview mirror assembly; and
wherein said circuit board is disposed in said mirror mount and wherein wiring passes through said pivot element to electrically connect said at least one accessory to said circuitry.

11. The interior rearview mirror assembly of claim 10, wherein said thickness dimension is less than about 15 mm.

12. The interior rearview mirror assembly of claim 10, wherein said accessory comprises a camera having a field of view through said mirror casing and through a windshield of the equipped vehicle.

13. The interior rearview mirror assembly of claim 10, wherein said accessory comprises a camera having a field of view through said reflective element and in a rearward direction with respect to the equipped vehicle.

14. The interior rearview mirror assembly of claim 10, wherein said reflective element comprises a variable reflectance electro-optic reflective element and wherein said accessory comprises an electro-optic mirror dimming feature, and wherein said circuitry includes circuit elements for controlling said electro-optic mirror dimming feature of said variable reflectance electro-optic reflective element.

15. The interior rearview mirror assembly of claim 10, wherein a camera is disposed at said circuit board and has a field of view through a windshield of the equipped vehicle.

16. The interior rearview mirror assembly of claim 10, wherein said mirror mount is configured to attach at an in-cabin surface of a windshield of the equipped vehicle.

17. The interior rearview mirror assembly of claim 10, wherein said mirror mount is configured to attach at a header portion of the equipped vehicle.

18. An interior rearview mirror assembly for a vehicle, said interior rearview mirror assembly comprising:
a mirror mount configured to attach at an interior portion of a vehicle equipped with said interior rearview mirror assembly;
a mirror head pivotally mounted at a pivot element of said mirror mount, said mirror head comprising a mirror casing and a variable reflectance electro-optic mirror reflective element;
wherein said mirror head comprises a reduced profile mirror casing having a thickness dimension between a front generally planar surface of said variable reflectance electro-optic mirror reflective element and a rear surface of a generally central region of said mirror casing, and wherein said thickness dimension is less than about 25 mm;
a circuit board disposed in said mirror mount;
wherein said circuit board includes circuitry and wherein said circuitry is associated with said variable reflectance electro-optic mirror reflective element;
wherein wiring passes through said pivot element to electrically connect said circuitry to terminals of said variable reflectance electro-optic mirror reflective element; and
wherein said circuitry is associated with a camera disposed at said mirror mount.

19. The interior rearview mirror assembly of claim 18, wherein one of (i) said camera has a field of view through a windshield of the equipped vehicle and (ii) said camera has a field of view rearward and views over an upper portion of said mirror head.

20. The interior rearview mirror assembly of claim 18, wherein said thickness dimension is less than about 20 mm.
